(19) United States
(12) Patent Application Publication
(10) Pub. No.: US 2024/0192677 A1
(43) Pub. Date: Jun. 13, 2024

(54) SYSTEM AND METHOD FOR DETECTING A DEVICE STATE

(71) Applicant: Rolls-Royce Deutschland Ltd & Co KG, Blankenfelde-Mahlow (DE)

(72) Inventor: Christian STANEK, Marquartstein (DE)

(21) Appl. No.: 18/553,559

(22) PCT Filed: Mar. 11, 2022
(86) PCT No.: PCT/EP2022/056364

§ 371 Date: Sep. 30, 2023

(30) Foreign Application Priority Data
Mar. 31, 2021 (DE) 10 2021 203 312.1

(51) Int. Cl. G05B 23/02; H01M 10/42

(52) U.S. Cl. CPC G05B 23/0281; H01M 10/4285; H01M 2220/20

(57) ABSTRACT

The invention relates to a system (1) for the automatic detection of a state of a device (2), comprising: a signal acquisition means (10) for acquiring defective measurement data (D) of a physical variable characterising the device (2); and an analysis unit (11) for identifying a specified pattern (M) in the measurement data (D) acquired by the signal acquisition means (10). The analysis unit (11) is designed:— to compare at least two different pattern sections (M1-M14) of the specified pattern (M) separately from each other with the measurement data (D):— on the basis of the respective comparison, to determine at least one position of each of the pattern sections (M1-M14) in the measurement data (D):— on the basis of the positions determined and the order of the positions of the pattern sections (M1-M14), to detect the specified pattern (M) at one or more positions in the measurement data (D) and,— on the basis of the one or more positions of the specified pattern (M), to determine the state of the device (2).

This application is the National Stage of International Application No. PCT/EP2022/056364, filed Mar. 11, 2022, which claims the benefit of German Patent Application No. DE 10 2021 203 312.1, filed Mar. 31, 2021. The entire contents of these documents are hereby incorporated herein by reference.

### BACKGROUND

The present disclosure relates to a system and a method for detecting a device state.

It is regularly necessary to monitor the state of devices in an automated manner. Measurement data is typically acquired for this purpose. The measurement data is informative for the state of the device. For this purpose, specific signatures may be searched for and analyzed in the measurement data. For example, a change of properties of the signature may indicate an imminent failure of the device. For example, in a device in the form of a drive machine, a vibration that becomes stronger over multiple acceleration maneuvers may indicate an increasingly deflected bearing and thus a state of the device requiring repair. A repair may thus be initiated by the state monitoring in a timely manner, even before the bearing fails and, for example, blocks the drive machine.

However, finding the signatures in the measurement data is regularly susceptible to error. In this way, the state of the corresponding device is often not correctly detected. One important reason for errors in automatically finding the signatures is regularly flawed measurement data (e.g., subject to measurement noise and/or generally statistical measurement inaccuracies).

In some applications (e.g., in the area of air travel), however, the most precise possible automatic state detection of one or more devices is generally necessary in order to preclude unexpected failure of one or more devices as well as possible.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, detection of a device state by pattern recognition in flawed measurement data is improved.

According to one aspect, a system for automatic detection of state of a device is provided. The system includes a signal acquisition unit for acquiring flawed measurement data of a physical variable describing the device. For example, the system includes a sensor for acquiring the physical variable or receives measurement signals from a corresponding sensor of the device. Further, the system includes an analysis unit for finding a predetermined pattern in the measurement data acquired by the signal acquisition unit, where the analysis unit is configured to: a) compare at least two different pattern sections of the predetermined pattern separately from one another with the measurement data; b) based on the respective comparison, acquire at least one position of each of the pattern sections in the measurement data; c) based on the acquired positions and the sequence of the positions of the pattern sections, detect the predetermined pattern at one or more positions in the measurement data; and d) based on the one or more positions of the predetermined pattern, ascertain the state of the device.

This is based on the finding that the detection of a predetermined pattern in flawed. For example, noisy measurement data often results in an incorrect detection of the pattern. This may result in the erroneous detection of the pattern at a position in the measurement data at which the pattern is actually not present. For this purpose, the predetermined pattern is thus divided into at least two sections (e.g., precisely two sections) that are searched for independently of one another in the measurement data. If the pattern sections are found after this search independent from one another in the correct sequence (e.g., accordingly the sequence of the pattern sections in the predetermined pattern) and, for example, adjacent to one another in the measurement data, it may be presumed with particularly high probability that the predetermined pattern is also actually present at the corresponding position in the measurement data. The rate of the incorrect detections of the pattern may be significantly reduced by the independent search. The ascertainment of the state of the device based on the one or more positions of the predetermined pattern in the measurement data may be carried out, for example, by the analysis of the measurement data at the one or more positions, for example, by a comparison to a threshold value, and/or by a comparison of the measurement data at multiple ascertained positions of the predetermined pattern with one another. In a simple example, the state of the device may already be detected by the detection of the position of the predetermined pattern in the measurement data as such, for example, if the predetermined pattern represents a signature for a specific state (e.g., a defect).

For example, the device is a battery. The physical variable is alternatively or additionally, for example, an electric variable (e.g., an electric voltage). Batteries (e.g., those that provide comparatively high amperages for operating a drive device for a vehicle, such as an aircraft) pass through usage-dependent aging processes and may have a defect upon increasing age or intensive use. Further, production errors may also exist. If such a defect or error is not detected in a timely manner, the battery may then fail and may no longer provide energy. This may be countered with short replacement intervals that may be accompanied by corresponding lifetimes and a high expenditure, however. In contrast, the state of the battery may be detected particularly reliably by the system described herein. The predetermined pattern describes, for example, the time curve of the electric voltage of a battery cell of the battery, or the entire battery, during a discharge process. By evaluating the measurement data at the one or more recognized positions of the predetermined pattern, the state of the device (e.g., the battery) may be ascertained particularly precisely, for example, in that a systematic (e.g., systematically increasing) deviation of the curve of the measurement data at the position or positions from the predetermined pattern is detected. It may be ascertained therefrom, for example, that the state requires maintenance or requires replacement. In general, the state may be ascertained as one of multiple predetermined statuses (e.g., of two predetermined statuses, such as functional and defective; or of three predetermined statuses, such as functional, requiring maintenance, and defective).

The analysis unit may be configured to compare the at least two different pattern sections of the predetermined pattern with the measurement data using dynamic time warping. In dynamic time warping (DTW), value sequences of different lengths are mapped on one another. In this way, for example, differently stretched sequences of the measurement data may be compared with the predetermined pattern. In the example of the battery, these may correspond, for example, to a slow and a fast discharge process.

The analysis unit is optionally configured to apply the dynamic time warping to at least one of the at least two different pattern sections of the predetermined pattern in order to generate one or more modified pattern sections. It may thus be sufficient for one type of a characteristic curve of the measurement data (e.g., a discharge process of the battery) to only store one predetermined pattern.

Further, the analysis unit may be configured to perform the acquisition of the at least one position of each of the pattern sections multiple times. At least one or at least two framework conditions may be changed, for example, over the multiple performances, and a number of positions of the predetermined pattern found in the measurement data may be ascertained per performance. A number of positions found that is ascertained most frequently in the multiple performances may be ascertained as the result for the number that is most probably actually accurate of positions of the predetermined pattern in the measurement data. Possible framework conditions are, for example, the width of a search window in the measurement data for the comparison to the pattern sections and/or a number of positions that may be found at most of the pattern sections and/or the predetermined pattern.

The device is optionally part of an aircraft. The above-mentioned advantages particularly come to bear here.

The at least one position of each of the pattern sections in the measurement data may be ascertained via a determination of a minimum overall deviation (e.g., a minimum Euclidean distance) between the respective pattern section and the measurement data at multiple positions of the measurement data. This permits a rapid and precise ascertainment.

The measurement data are, for example, time series data. The one or more positions of the predetermined pattern may each specify a point in time or a period of time in the measurement data.

The system may also include a display device. The analysis unit is optionally configured to output the ascertained state of the device at the display device. Alternatively or additionally, the analysis unit has a communication connection to the device. The analysis unit is, for example, configured to control and/or switch off the device based on the ascertained state of the device.

Optionally, the analysis unit includes an artificial neural network and is configured to train the artificial neural network by the one or more positions of the predetermined pattern in the measurement data. In this manner, a particularly reliably trained neural network that permits a particularly accurate ascertainment of the state of the device may be obtained.

The position detection of the predetermined pattern permits automatic labeling of the measurement points that define the pattern. Such labeling enables automatic preparation for the training of neural networks.

According to one aspect, a method for automatic detection of state of a device is provided. In the method, the system according to any embodiment described herein may be used. The method includes acquiring, by a signal acquisition unit, flawed (e.g., noisy) measurement data of a physical variable describing the device, and finding, by an analysis unit, a predetermined pattern in the measurement data acquired by the signal acquisition unit. This finding includes comparing at least two different pattern sections of the predetermined pattern with the measurement data separately from one another, acquiring at least one position of each of the pattern sections in the measurement data based on the respective comparison, detecting the predetermined pattern at one or more positions in the measurement data based on the acquired positions and the sequence of the positions of the pattern sections, and ascertaining the state of the device based on the one or more positions of the predetermined pattern.

The method optionally also includes outputting, by the analysis unit, the ascertained state of the device at a display device.

### BRIEF DESCRIPTION OF THE DRAWINGS

FIG. 1 shows an aircraft in the form of an airplane having a battery and a propeller driven electrically by the battery;

FIG. 2 shows a device and a system for automatic state detection of the device;

FIGS. 3 and 4 show diagrams having various measurement data of an electric voltage of the battery of the airplane according to FIG. 1;

FIGS. 5 and 6 show diagrams to explain the detection of a pattern in measurement data;

FIGS. 7 and 8 each show numbers of positions of a predetermined pattern, ascertained using various framework conditions, in the measurement data according to FIGS. 3 and 4; and

FIG. 9 shows a method for automatic detection of state of a device.

### DETAILED DESCRIPTION

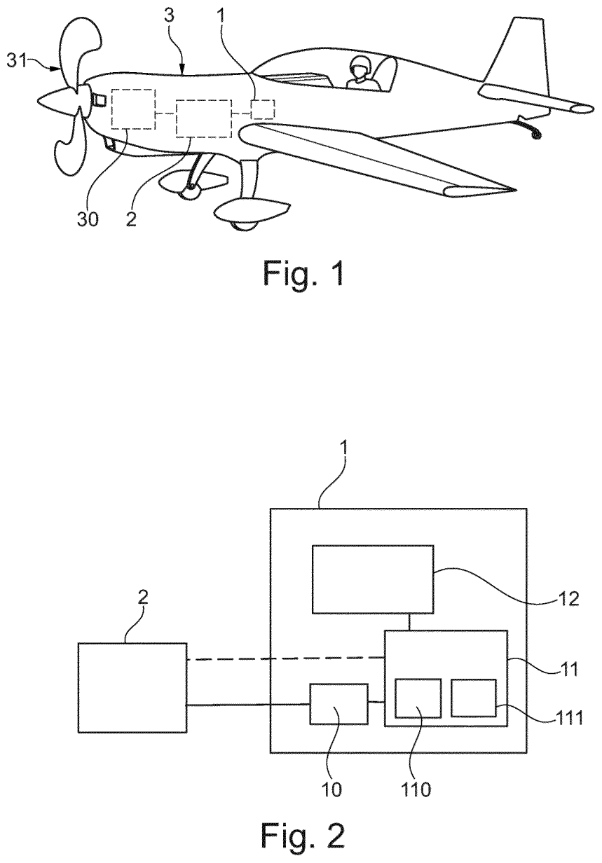

FIG. 1 shows an aircraft 3 in the form of an electrically driven airplane. The aircraft 3 includes a propeller 31 that is driven by an electric machine 30 in the form of an electric motor.

The aircraft 3 also includes a device in the form of a battery 2. The electric machine 30 is electrically connected to the battery 2 and is thus supplied with energy. The electric machine 30 is optionally used as a generator and is configured to provide electric energy to the battery 2.

The battery 2 may have a state worsened in relation to a proper state due to environmental influences, usage, and/or age. Further, the battery 2 may have a critical state that has increased probability of being followed by a defect comparatively soon. To automatically monitor the state of the battery 2, the aircraft 3 includes a system 1 for automatic detection of state of a device (e.g., the battery 2).

FIG. 2 shows a schematic illustration of the battery 2 and the system 1 for automatic state detection.

The system 1 includes a signal acquisition unit 10 and an analysis unit 11. In FIG. 2, these two components are shown separately; however, the signal acquisition unit 10 and the analysis unit 11 may also be formed by common hardware and/or software.

The signal acquisition unit 10 is operationally connected to the battery 2 in the present case, such that the signal acquisition unit 10 may acquire a voltage of the battery 2 (e.g., a voltage of a cell or, as in the example shown, a voltage of all battery cells (or a voltage of each cell respectively) of the battery 2). This cell voltage indicates a state of charge of the cell. Upon discharge of a specific power by the cell, the voltage sinks with a characteristic curve. Deviations from this characteristic curve may indicate worsening of the state of the cell.

In general, the signal acquisition unit 10 is configured to acquire measurement data of a physical variable (e.g., the cell voltage) of a device (e.g., the battery 2).

The signal acquisition unit 10 provides the acquired measurement data to the analysis unit 11. The signal acquisition unit 10 includes an analog-to-digital converter for this purpose in the present case. The analysis unit 11 is configured to find a predetermined pattern in the measurement data acquired by the signal acquisition unit 10 in that, as will be explained in more detail hereinafter, the analysis unit 11: compares at least two different pattern sections of the predetermined pattern separately from one another with the measurement data; based on the respective comparison, acquires at least one position of each of the pattern sections in the measurement data; based on the acquired positions and a sequence of the positions of the pattern sections, detects the predetermined pattern at one or more positions in the measurement data; and based on the one or more positions of the predetermined pattern, ascertains the state of the device.

For this purpose, the analysis unit 11 in the example shown includes a processor 110 and a memory 111 for storing instructions executable by the processor.

In one embodiment, the system 1 includes a display device 12 for displaying the state ascertained by the analysis unit 11.

The analysis unit 11 may have a communication connection to the device (e.g., the battery 2). The analysis unit 11 is configured to control (e.g., regulate) the device based on the ascertained state of the device (e.g., the battery 2). For example, the analysis unit 11 is configured to switch off the device (e.g., open an electric current including the device) based on the ascertained state of the device (e.g., the battery 2).

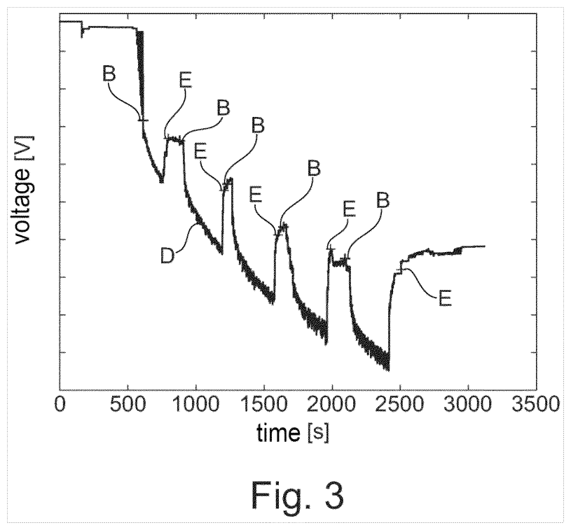

FIG. 3 shows measurement data D of the cell voltage of the battery 2 over a time span of a flight of the aircraft 3. Full thrust was requested multiple times (e.g., five times) over a period of time, which results in a removal of energy from the battery 2 in each case. This is detectable in the diagram shown by five characteristic signatures. The signatures each extend from a beginning B to an end E. The precise curve of these signatures, for example, in comparison to one another and/or in comparison to a reference signature permits inferences about the state of the battery 2, (e.g., whether the battery requires maintenance or approaches an end of the lifetime).

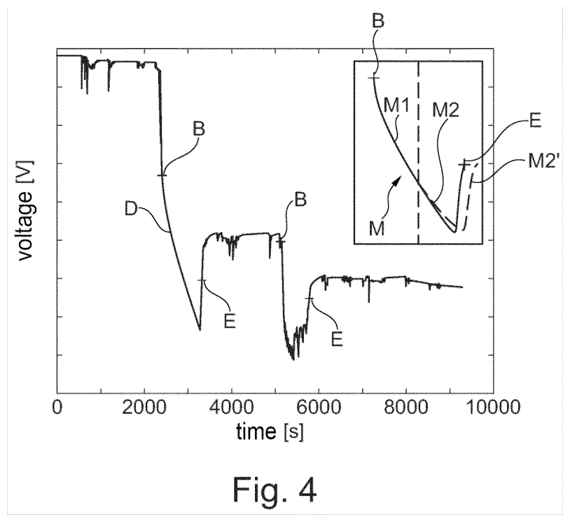

FIG. 4 shows measurement data D of the cell voltage of the battery 2 over a time span of another flight of the aircraft 3. Full thrust was requested two times therein.

On the top right in the diagram of FIG. 4, the predetermined pattern M is shown, which is compared by the analysis unit 11 with the measurement data D in order to ascertain the positions of the pattern M in the measurement data D (e.g., in FIG. 3, the five positions; in FIG. 4, the two positions). A division of the predetermined pattern M into two half pattern sections M1, M2 is also shown here.

In the comparison, for example, a DTW algorithm is applied in order to take into consideration requests for thrust of various lengths and/or requests for thrust less than full thrust and/or to take into consideration various absolute values of the measurement data. For example, using DTW, the respective pattern section M1, M2 (e.g., alternatively or additionally the entire predetermined pattern M) is scaled, for example, along the time axis and/or along the axis of the measured value at the respective point in time in order to obtain a modified pattern section M2′.

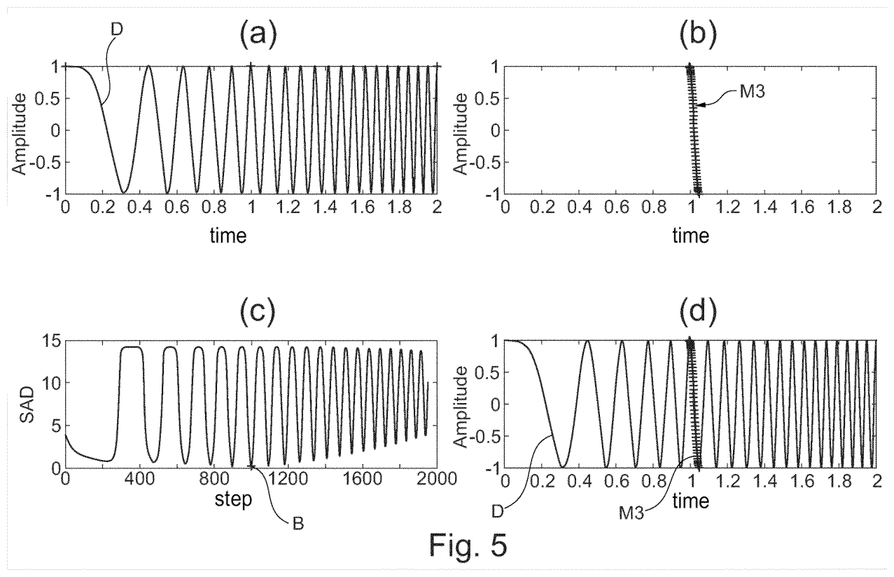

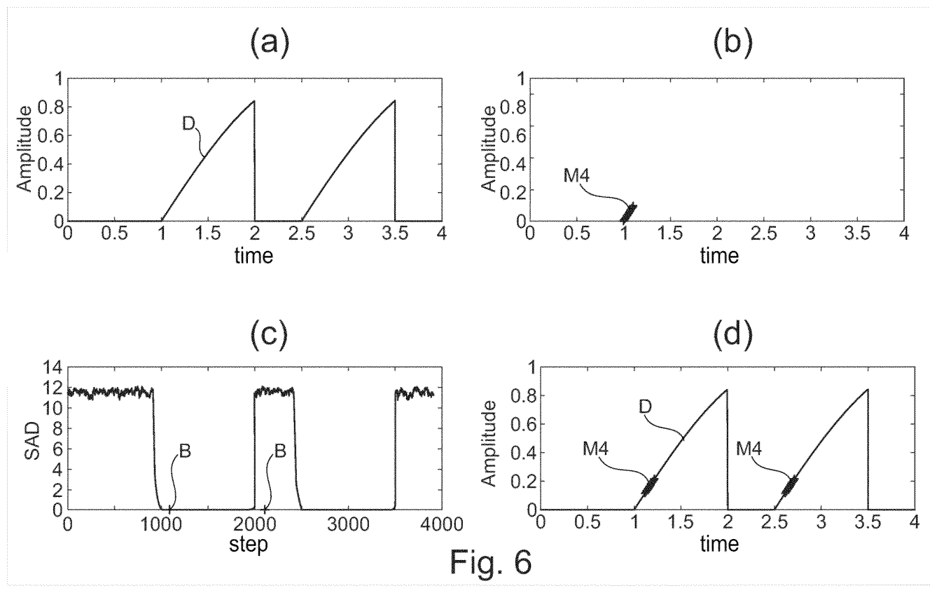

The search for the individual pattern sections M1, M2 in the measurement data D will be explained hereinafter based on FIGS. 5 and 6, where very differently progressing measurement data D are shown for illustration, each in diagram (a) of FIGS. 5 and 6. For example, an amplitude of a physical variable is plotted against time in each case therein.

The respective diagram (b) shows a pattern section M3, M4 of a predetermined pattern. In order to rediscover this pattern section M3, M4 once or multiple times in the measurement data D, the pattern section M3, M4 is compared step-by-step with the measurement data D (e.g., with each section of the measurement data D). The overall deviation of the pattern section M3, M4 from a specific section of the measurement data D is thus ascertained, for example, in the form of the sum of the absolute deviations (SAD), as shown in the respective diagram (c). The point at which the overall deviation has a minimum corresponds to the most probable position of the pattern section M3, M4 in the measurement data D. If multiple occurrences of the pattern section M3, M4 are ascertained and/or permitted in the ascertainment, the most probable positions thereof are thus the corresponding number of the smallest minima. In FIGS. 5 and 6, the respective beginning B of such a pattern section M3, M4 detected in the measurement data is shown.

The respective diagram (d) shows the measurement data D having the pattern sections M3, M4 overlaid thereon.

This search for one or more positions of the pattern sections M3, M4 is carried out by the analysis unit 11 for all (e.g., two) pattern sections M1-M4 of the measurement data D. Sometimes, more occurrences of the separate pattern sections M1-M4 may be found, for example, in the measurement data D than are actually present. However, if an adjacent sequence of (e.g., all of) the pattern sections M1-M4 of the predetermined pattern M in the correct sequence is ascertained, then this is a particularly reliable indication of the presence of the predetermined pattern. In this case, each pattern section M1-M4 may be assigned a character, so that the sequence of the pattern sections M1-M4 may be processed by the analysis unit 11 in the form of a character chain. This permits particularly efficient and rapid processing.

Referring again to FIG. 4, the sequence M1, M2 will thus be found twice. This calculation may be performed automatically and quickly by the processor 110, and also comprehensibly and reproducibly, in contrast to the case of a use of a neural network for this purpose. Further, no training is necessary for this purpose. The algorithm is therefore regularly better suitable than an algorithm based on neural networks for authorization in the aviation sector. In contrast, a high number of “faulty” and “good” events is regularly to be provided for training of a neural network.

The positions of the predetermined pattern M in the measurement data D is specified, for example, by the respective beginning B and/or the respective end E (e.g., the corresponding point in time).

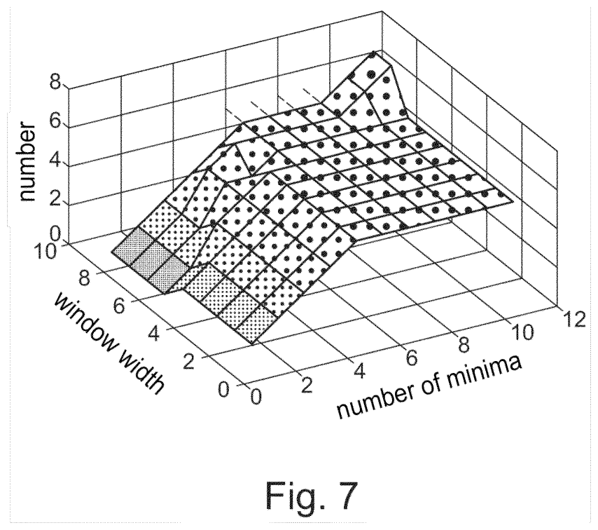

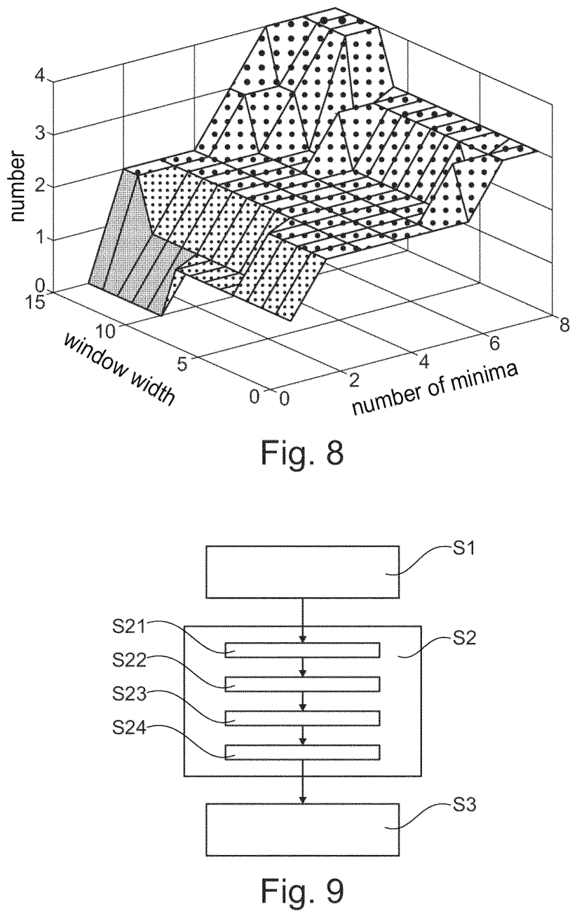

The search may be made more precise by a variation of framework conditions in the search. FIGS. 7 and 8 thus show the respectively ascertained numbers of adjacent sequences of (e.g., all of) the pattern sections M1-M2 of the predetermined pattern M in the correct sequence upon a search having a varied number of the permitted maximum minima and the window width of the measurement data D and/or the pattern section M1-M2 in the comparison to the respective pattern section M1-M2. However, these are solely examples of possible framework conditions.

In both cases, a plateau is shown at, for example, a number of five (see FIG. 7) or two (see FIG. 8) detected occurrences of the predetermined pattern M in the measurement data D. The number indicated by the plateau may be used as the result for the number of the ascertained occurrences of the predetermined pattern M in the measurement data D. A particularly robust ascertainment of this number is thus enabled. In this manner, false positive ascertained patterns may be substantially or completely precluded. This also applies, for example, if the obtained measurement data D is noisy, for example, due to environmental influences or due to electromagnetic interference signals from surrounding components, since these may induce false minima.

Since the number may thus be ascertained robustly, it is possible to determine the corresponding positions in the measurement data particularly accurately. The analysis unit 11 may thus be configured to perform the search multiple times using varied framework conditions and then search in the obtained results of the number of the positions for a plateau and/or a most frequently occurring value.

FIG. 9 shows a method for automatic detection of state of a device (e.g., the battery 2).

In act S1, a signal acquisition unit 10 acquires measurement data D (e.g., flawed measurement data D) of a physical variable (e.g., cell voltage) describing the device (e.g., the battery 2).

In act S2, the analysis unit 11 finds a predetermined pattern M in the measurement data D acquired by the signal acquisition unit 10. Act S2 includes substeps S21 to S24.

In act S21, at least two different pattern sections M1-M4 of the predetermined pattern M are compared separately from one another to the measurement data D.

In act S22, at least one position of each of the pattern sections M1-M4 in the measurement data D is acquired based on the respective comparison.

In act S23, the predetermined pattern M is detected at one or more positions in the measurement data D based on the acquired positions and a sequence of the positions of the pattern sections M1-M4.

In act S24, the state of the device (e.g., battery 2) is ascertained based on the one or more positions of the predetermined pattern M.

In act S3, the analysis unit 11 outputs the ascertained state of the device (e.g., battery 2) at a display device 12 and/or controls the device (e.g., battery 2) based on the ascertained state.

For example, a cell voltage of a battery 2 is discussed above, where a measurement is also possible, for example, of other electrical or mechanical variables (e.g., of phase currents, a (different) DC or AC voltage, an amperage, a speed, and/or a torque as a respective physical variable of electric aircraft engines, and/or a derived variable such as mechanical power, electric power, active power, apparent power, cosine phi, efficiency, and/or a control variable of the respective device). The following may be provided, for example, as devices in electric aircraft engines: motor, inverter, battery, energy/power distribution unit, and/or controller.

The invention is not restricted to the embodiments described above, and various modifications and improvements may be made without departing from the concepts described herein. Any of the features may be used separately or in combination with any other features, unless the features are mutually exclusive. The disclosure extends to and includes all combinations and subcombinations of one or more features that are described herein.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for automatic detection of state of a device, the system comprising:
a signal acquisition unit configured to acquire measurement data of a physical variable describing the device, the measurement data being flawed measurement data; and
an analysis unit configured to find a predetermined pattern in the measurement data acquired by the signal acquisition unit, wherein the analysis unit is configured to:
compare at least two different pattern sections of the predetermined pattern separately from one another with the measurement data;
acquire, based on the respective comparison, at least one position of each of the at least two different pattern sections in the measurement data;
detect, based on the acquired positions and a sequence of the positions in the at least two different pattern sections the predetermined pattern at one or more positions in the measurement data; and
ascertain, based on the one or more positions of the predetermined pattern, the state of the device.

2. The system of claim 1, wherein the device is a battery, and the physical variable is an electric voltage.

3. The system of claim 1, wherein the analysis unit is further configured to compare the at least two different pattern sections of the predetermined pattern with the measurement data using dynamic time warping.

4. The system of claim 3, wherein the analysis unit is further configured to apply the dynamic time warping to at least one of the at least two different pattern sections of the predetermined pattern, such that at least one modified pattern section is generated.

5. The system of claim 1, wherein the analysis unit is further configured to perform the acquisition of the at least one position of each of the at least two different pattern sections multiple times,
wherein at least two framework conditions are changed over the multiple performances, and a number of positions of the predetermined pattern found in the measurement data (D) per performance is ascertained,
wherein a number of positions found that is ascertained most frequently in the multiple performances is ascertained as a result for the number of positions of the predetermined pattern in the measurement data.

6. The system of claim 1, wherein the device is part of an aircraft.

7. The system of claim 1, wherein the acquisition of the at least one position of each of the at least two different pattern sections in the measurement data comprises ascertainment via a determination of a minimum overall deviation between the respective pattern section and the measurement data at multiple positions of the measurement data.

8. The system of claim 1, wherein the measurement data is time series data, and the one or more positions of the predetermined pattern each specify a point in time or period of time in the measurement data.

9. The system of claim 1, further comprising a display device, wherein the analysis unit is further configured to output the ascertained state of the device at the display device.

10. The system of claim 1, wherein the analysis unit comprises an artificial neural network and is further configured to train the artificial neural network using the one or more positions of the predetermined pattern in the measurement data.

11. A method for automatic detection of state of a device, the method comprising:
acquiring, by a signal acquisition unit, measurement data of a physical variable describing the device, the measurement data being flawed measurement data;
finding, by an analysis unit, a predetermined pattern in the measurement data acquired by the signal acquisition unit, the finding comprising, comprising:
comparing at least two different pattern sections of the predetermined pattern separately from one another with the measurement data;
acquiring at least one position of each of the at least two different pattern sections in the measurement data based on the respective comparison;
detecting the predetermined pattern at one or more positions in the measurement data based on the acquired positions and a sequence of the positions of the pattern sections; and
ascertaining the state of the device based on the one or more positions of the predetermined pattern.

12. The method of claim 11, further comprising:
outputting, by the analysis unit, the ascertained state of the device at a display device.
